(19) United States
(12) Patent Application Publication
(10) Pub. No.: US 2024/0420400 A1
(43) Pub. Date: Dec. 19, 2024

(54) TERMINAL, INFORMATION PROCESSING METHOD, PROGRAM, AND RECORDING MEDIUM

(71) Applicant: POPOPO INC., Tokyo (JP)

(72) Inventor: Shinnosuke IWAKI, Tokyo (JP)

(73) Assignee: POPOPO INC., Tokyo (JP)

(21) Appl. No.: 18/701,437

(22) PCT Filed: Oct. 31, 2022
(86) PCT No.: PCT/JP2022/040723

§ 371 Date: Apr. 15, 2024

(30) Foreign Application Priority Data
Nov. 1, 2021 (JP) 2021-178513

(51) Int. Cl. G06T 13/20

(52) U.S. Cl. CPC G06T 13/205

(57) ABSTRACT

A terminal (10) for participating in a conference held in a virtual space in which an avatar of a participant is arranged, including: a collecting unit (11) for collecting a voice of the participant; a control unit (13) for generating control data for controlling the avatar of the participant; a determining unit (14) for determining a state of the participant; a transmitting unit (15) for transmitting voice data, the control data, and a determination result of the participant; a receiving unit (16) for receiving voice data, control data, and a determination result of another participant; a display control unit (17) for determining a display mode of the conference based on the determination result of the participant and the other participant; and a display unit (18) for reproducing the voice data, controlling the avatar based on the control data, and displaying a screen of the conference according to the display mode.

### TECHNICAL FIELD

The present invention relates to a terminal, an information processing method, a program, and a recording medium.

### BACKGROUND ART

In recent years, a remote conference using each participant's terminal is held actively. In the remote conference, a camera and a microphone are connected to a personal computer, and videos and voices of each participant are transmitted via a network. A portable terminal such as a smartphone equipped with an in-camera is sometimes used.

### CITATION LIST

### Patent Literature

Patent Literature 1: JP 2014-225801 A

### SUMMARY OF THE INVENTION

### Problems to be Solved by the Invention

In a conventional remote conference system that arranges and displays captured videos of participants using cameras, there is a problem that many participants face a direction of one participant and therefore the participant feels pressure. Further, it may be stressful for each participant to participate in the conference by showing each participant himself/herself.

By turning off the camera and displaying an icon representing each participant instead of the captured videos, the stress that each participant is being watched by other persons is reduced, but there is a problem that responses from other participants are not sufficient and a speaker is less likely to notice good reactions.

In a conference system disclosed in Patent Literature 1, a conference participant is expressed as a virtual avatar. In Patent Literature 1, the degree of positivity, which is an index indicating a positive attitude toward the conference, is determined based on a behavior of each participant obtained using a camera, and the degree of positivity is reflected in an avatar of each participant. In Patent Literature 1, an avatar is displayed instead of each participant himself/herself, and therefore the stress that each participant is being watched by other persons is reduced. However, since the degree of positivity is determined for each participant and the degree of positivity is reflected in an avatar, it may be stressful for each participant because each participant feels that he/she needs to show a positive attitude in front of the camera.

The present invention has been made in consideration of such problems as described above, and an object of the present invention is to provide a conference system which allows a participant to easily participate in a remote conference and the remote conference to proceed smoothly while reducing the stress of the remote conference.

### Means to Solve the Problems

A terminal of one aspect of the present invention is a terminal for participating in a conference held in a virtual space in which an avatar of a participant is arranged, the terminal including: a collecting unit for collecting a voice of the participant; a control unit for generating control data for controlling the avatar of the participant; a determining unit for determining a state of the participant; a transmitting unit for transmitting voice data, the control data, and a determination result of the participant; a receiving unit for receiving voice data, control data, and a determination result of another participant; a display control unit for determining a display mode of the conference based on the determination result of the participant and the determination result of the other participant; and a display unit for reproducing the voice data, controlling the avatar based on the control data, and displaying a screen of the conference according to the display mode.

### Effects of Invention

According to the present invention, it is possible to provide a conference system which allows a participant to easily participate in a remote conference and the remote conference to proceed smoothly while reducing the stress of the remote conference

### BRIEF DESCRIPTION OF DRAWINGS

FIG. 1 is a diagram showing an example of an entire configuration of a conference system of the present embodiment.

FIG. 2 is a functional block diagram showing an example of a configuration of a terminal in the conference system of the present embodiment.

FIG. 3 is a flowchart showing an example of a flow of processing for the terminal to transmit data.

FIG. 4 is a flowchart showing an example of a flow of processing for the terminal to display a screen of a conference.

FIG. 5 is a diagram showing an example of a display screen of the conference.

FIG. 6 is a flowchart showing an example of a flow of processing for the terminal to display the screen of the conference.

FIG. 7 is a diagram showing an example of a display of an avatar having a conversation.

FIG. 8 is a diagram showing an example of a display of an avatar having a conversation.

FIG. 9 is a diagram showing an example of a display of avatars having a conversation.

FIG. 10 is a flowchart showing an example of a flow of processing that allows avatars having a conversation to be close to each other.

FIG. 11 is a diagram showing an example on how avatars having a conversation can be close to each other.

FIG. 12 is a diagram showing an example of a screen in which icons are arranged.

FIG. 13 is a diagram showing an example of a screen displayed when a participant selects an icon.

### DESCRIPTION OF EMBODIMENT

### Example 1

An embodiment of the present invention will be described below with reference to drawings.

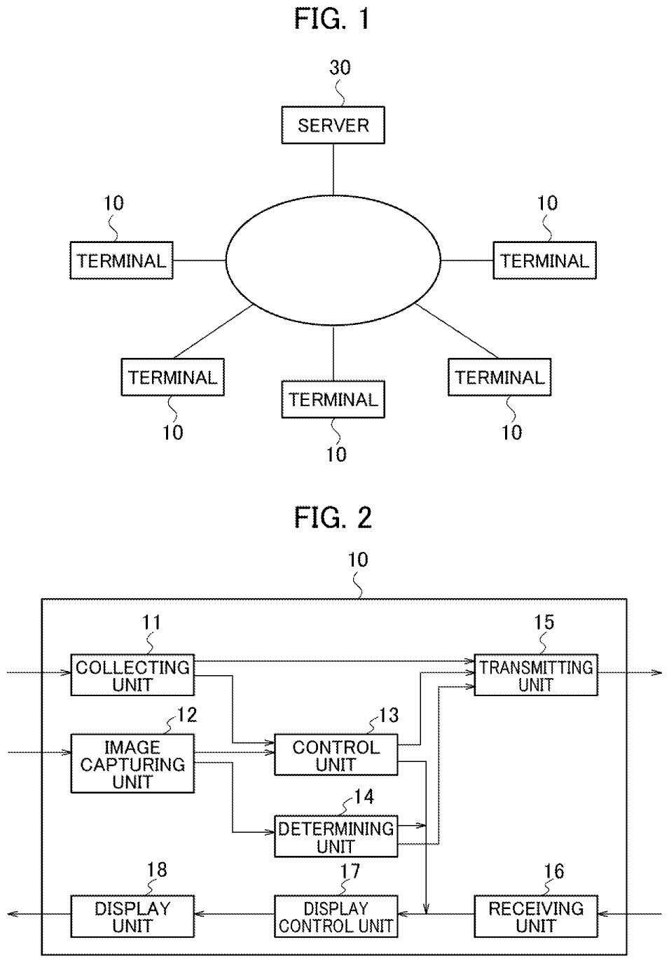

In a conference system shown in FIG. 1, participants participate in a remote conference held in a virtual space using terminals 10. The conference system includes the plurality of terminal 10 and a server 30 communicatively connected via a network. Although the number of terminals 10 is five in FIG. 1, the number is not limited thereto, and the number of terminals 10 that can participate in the remote conference is arbitrary.

An avatar corresponding to each participant is arranged in the virtual space. An avatar is a computer graphic character that represents a participant participating in a remote conference. Each participant participates in a conference in a virtual space as an avatar using each terminal 10. The conference also includes a chat such as a content-free chat.

Each terminal 10 collects voices of each participant using a microphone, captures an image of each participant using a camera, and generates control data for controlling the movement and posture of an avatar of each participant. Each terminal 10 transmits voice data and the control data of of each participant. Each terminal 10 receives voice data and control data of another participant, outputs the voice data, controls a corresponding avatar according to the control data, and displays a video obtained by rendering the virtual space. Further, each terminal 10 determines a state of each participant and transmits a determination result, receives a determination result of a state of the other participant from another terminal 10, and determines a display mode of a conference based on the determination result of each participant and the determination result of the other participant.

Each terminal 10 may be a personal computer to which a camera and a microphone are connected, a portable terminal such as a smartphone equipped with an in-camera, or a virtual reality (VR) device equipped with a controller and a head mounted display (HMD).

The server 30 receives control data, voice data, and a determination result from each terminal 10 and distributes them to each terminal 10.

An example of a configuration of the terminal 10 will be described with reference to FIG. 2. The terminal 10 shown in FIG. 2 includes a collecting unit 11, an image capturing unit 12, a control unit 13, a determining unit 14, a transmitting unit 15, a receiving unit 16, a display control unit 17, and a display unit 18. Each unit of the terminal 10 may be constituted by a computer having an arithmetic processor, a storage device, and the like, and processing of each unit may be executed by a program. The program is stored in a storage device of the terminal 10, and may be recorded on a recording medium such as a magnetic disk, an optical disk, or a semiconductor memory, or may be provided through a network.

The collecting unit 11 collects voices of a participant using a microphone of the terminal 10 or a microphone connected to the terminal 10. The collecting unit 11 may receive voice data of the participant recorded using another device.

The image capturing unit 12 captures an image of a participant using a camera of the terminal 10 or a camera connected to the terminal 10. A face of the participant may be in the captured video, the whole body of the participant may be in the video, or the participant may not be in the video. The image capturing unit 12 may receive an image captured using another device.

The control unit 13 generates control data for controlling the avatar of the participant. The control unit 13 may generate control data based on at least one of a voice and captured image of the participant. As a simple example, the control unit 13 generates control data so as to close a mouth of the avatar when the participant is not speaking and generates control data so as to move the mouth of the avatar according to speech when the participant is speaking. The control unit 13 may determine an action of the avatar based on an expression of the participant in the captured image.

Alternatively, the control unit 13 may generate control data without reflecting a state of the participant. If the participant is turning sideways without looking at a screen of a conference, or if the participant is no longer in front of a camera, the control unit 13 generates control data for causing the avatar to act naturally in the conference such as nodding or turning toward a speaker to see the speaker, without faithfully reflecting a movement of the participant to the avatar, for example. If the participant shows a positive attitude to the conference, such as when the participant is looking at the screen and nodding at the screen, the control unit 13 may generate control data reflecting a movement of the participant to the avatar. This allows the speaker to comfortably speak even if the participant is in any state, because the avatar of the participant shows a response or a reaction during the conference.

The control unit 13 may use a machine learning model that has learned a voice and a movement of an avatar, input a voice into the machine learning model, and generate control data for an avatar.

When a VR device is used as the terminal 10, the control unit 13 generates control data for controlling an avatar based on inputs from a controller and an HMD. Hand gestures and head movements of a participant are reflected in the avatar.

The determining unit 14 determines the state of the participant from the captured image. Specifically, the determining unit 14 determines, from the captured image, whether the participant is looking at a screen of the conference and whether the participant is present. The determination made by the determining unit 14 may not be exact, for example, and if the participant is using a smartphone as the terminal 10, the determining unit 14 determines that the participant is looking at the screen if a frontal face is in the captured image. Further, the determining unit 14 may determine whether the participant is speaking from the captured image or voice data.

The transmitting unit 15 transmits voice data, control data, and a determination result. The determination result is information indicating the state of the participant determined by the determining unit 14. The determination result includes states such as the participant looking at the screen, the participant not looking at the screen, the participant being in front of the camera, the participant not being in front of the camera, and the participant in speech, for example. The determination result may include time information such as a time when the participant is looking at the screen, a time when the participant is not in front of the camera, or a speech time. The transmitted data is distributed to each terminal 10 via the server 30.

The receiving unit 16 receives voice data, control data, and a determination result from another terminal 10 via the server 30.

The display control unit 17 totals determination results received from the determining unit 14 and the other terminal 10, and determines a display mode of the conference based on the totaled result. The display mode includes a viewpoint when rendering a virtual space, division of the screen into frames, arrangement of objects, the movement and posture of the avatar and various effects, for example. Examples of the totaled result and display mode will be described below.

If a proportion of participants who are not looking at the screen is more than a prescribed threshold, the display control unit 17 sets the viewpoint when rendering the virtual space to a viewpoint in which a close-up of a speaker is shown in order to attract the attention of the participants. At this time, the display control unit 17 may have an avatar of the speaker perform a large action such as hitting a desk, or may turn up the volume of a voice of the speaker. When the avatar of the speaker is made to perform the large action, the display control unit 17 replaces control data of the avatar of the speaker with control data of the large action.

If the proportion of the participants who are not looking at the screen is more than the prescribed threshold and there is no speaker, the display control unit 17 sets the viewpoint when rendering the virtual space to a viewpoint in which a close-up of an avatar of an organizer (facilitator) of the conference is shown in order to promote the transition to a next topic or the end of the conference.

When the majority of the participants are looking at the screen, the display control unit 17 may set the viewpoint when rendering the virtual space to a viewpoint in which an entire conference room is overlooked, and perform a production in which the participants are listening to a speech intently. The display control unit 17 may select several avatars at random and make them nod. When making the avatars nod, the display control unit 17 replaces control data of the target avatars with control data of a nodding action.

In this way, by totaling the states of the participants and determining the display mode of the conference based on the totaled result, the conference can proceed smoothly.

The display unit 18 reproduces received voice data, arranges an object including an avatar in the virtual space according to an instruction from the display control unit 17, controls a movement and posture of the avatar based on control data, and generates a video of the conference by rendering the virtual space. The display unit 18 arranges an object such as a floor, a wall, a ceiling, or a table constituting the conference room in the virtual space, and arranges an avatar of a participant at a prescribed position, for example. Model data and an arrangement position of the object is stored in a storage device of the terminal 10. Information necessary for constructing the virtual space may be received from the server 30 or another device when participating in the conference. If the instruction from the display control unit 17 includes a change in a position of the object and changes in a position and posture of the avatar, the display unit 18 changes the position of the object and the position and posture of the avatar according to the instruction. If the instruction from the display control unit 17 specifies a viewpoint, the display unit 18 renders the virtual space with the specified viewpoint.

The display unit 18 may arrange an operation button on the screen and receive an operation from each participant. When the operation button is pressed, control data is transmitted which is for making an avatar of each participant move according to the operation button, for example.

The server 30 may perform a part of functions of the terminal 10. The server 30 may have functions of the display control unit 17, determine a display mode by totaling determination results from each terminal 10, and distribute the display mode to each terminal 10, for example. The server 30 may have functions of the control unit 13, the determining unit 14, and the display control unit 17, receive a captured image and voice data from each terminal 10, generate control data for each avatar, determine a state of each participant, determine a display mode by totaling determination results, and distribute the control data and the display mode to each terminal. The server 30 may have functions of the display unit 18, and distribute the video obtained by rendering the virtual space to the terminal 10.

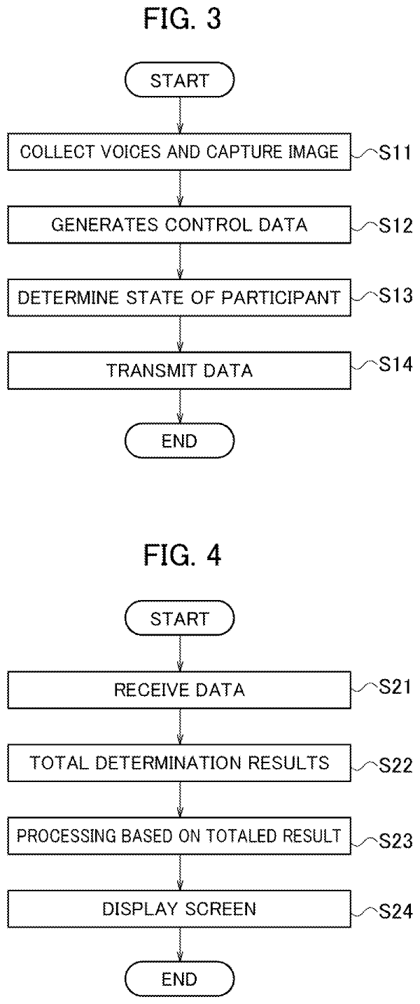

Next, a flow of processing of the terminal 10 will be described with reference to flowcharts of FIGS. 3 and 4. The processing shown in FIGS. 3 and 4 is performed by each terminal 10 as needed.

FIG. 3 is a flowchart showing an example of a flow of processing for the terminal 10 to transmit data.

In step S11, the collecting unit 11 collects voices of a participant and the image capturing unit 12 captures an image of the participant.

In step S12, the control unit 13 generates control data for controlling an avatar of the participant.

In step S13, the determining unit 14 determines a state of the participant from the captured image or voices.

In step S14, the transmitting unit 15 transmits the voice data, control data, and determination result. The transmitted data is distributed to each terminal 10 via the server 30.

FIG. 4 is a flowchart showing an example of a flow of processing for the terminal 10 to display a screen of a conference.

In step S21, the receiving unit 16 receives pieces of data transmitted by another terminal 10 from the server 30. The pieces of received data are voice data, control data, and determination results, for example.

In step S22, the display control unit 17 totals the received determination results.

In step S23, the display control unit 17 determines a display mode of the conference based on the totaled result.

In step S24, the display unit 18 reproduces the voice data, controls the avatar according to the control data, and displays the screen of the conference according to the display mode.

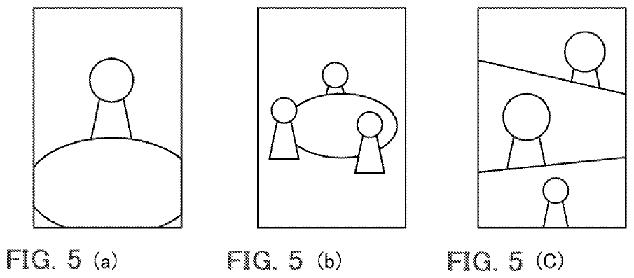

FIG. 5 is a diagram showing an example of a display screen of a conference. FIG. 5(a) is an example of a screen displaying an avatar of a speaker. FIG. 5(b) is an example of a screen displaying an entire conference room from a viewpoint in which the entire conference room is overlooked. FIG. 5(c) is an example of a screen in which the screen is divided into frames and an avatar of each participant is displayed in each frame. A display mode of a screen may be determined by each terminal 10 based on a totaled result obtained by totaling determination results of states of a participant, or may be determined randomly by each terminal 10. All of the terminals 10 may or may not display a screen in the same display mode. That is, each terminal 10 may individually determine a display mode, or a display mode determined by any one of the terminals 10 may be distributed to each terminal 10 such that each terminal 10 has the same display mode.

### Example 2

In Example 2, a display mode of a conference is determined with reference to determination results of states of a participant and the past shot breakdown. An entire configuration of a conference system of Example 2 and a configuration of a terminal 10 are basically the same as those of Example 1. In Example 2, a determining unit 14 determines whether a participant is in a conversation, and a display control unit 17 specifies the participant who is in the conversation, based on the determination results and determines a shot breakdown of an avatar of the participant who is in the conversation, based on the past shot breakdown. In Example 2, the terminal 10 may not include an image capturing unit 12.

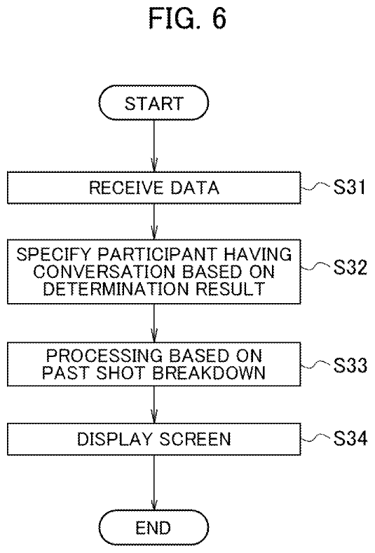

With reference to a flowchart of FIG. 6, a description will be give regarding processing for the terminal 10 of Example 2 to display a screen of a conference. Processing for the terminal 10 to transmit data is the same as that in Example 1.

In step S31, a receiving unit 16 receives, from a server 30, data transmitted by another terminal 10.

In step S32, the display control unit 17 specifies the participant who is in the conversation, based on the received determination results. If another participant B starts speaking within a prescribed time after an end of a speech made by a certain participant A, it is determined that the participants A and B are in the conversation.

In step S33, the display control unit 17 determines the display mode of the conference based on the past shot breakdown. A specific example of processing based on the past shot breakdown will be described later.

In step S34, a display unit 18 reproduces voice data, controls an avatar according to control data, and displays the screen of the conference according to the display mode.

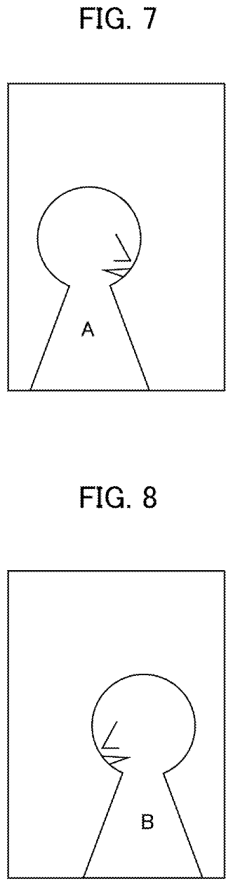

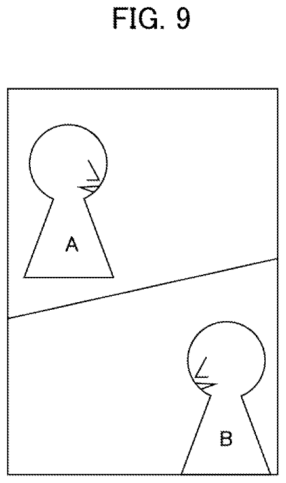

An example of processing based on the past shot breakdown will be described. As shown in FIG. 7, suppose that in the past, an avatar A of the participant A has been displayed in a shot breakdown in which the avatar A faces the right side of the screen. The display control unit 17 stores the past shot breakdown in which an avatar of a participant who is in a conversation is displayed. If the participant A is a speaker who is in the conversation, the display control unit 17 sets a display mode to the shot breakdown in which the avatar A faces the right side of the screen in the same way as the past shot breakdown. If a person with whom the participant A is having a conversation is the participant B, when displaying an avatar B of the participant B, the display control unit 17 sets a shot breakdown in which the avatar B faces the left side of the screen as shown in FIG. 8 such that the avatar A and the avatar B face each other. Thereafter, when the participant B speaks, the display control unit 17 makes the avatar B face the left side of the screen. The display control unit 17 may control a posture of an avatar.

If, in the past, the avatar A and the avatar B have been displayed in a shot breakdown in which both of them face the right side, the display control unit 17 displays a screen in which both of the avatar A and the avatar B are displayed, the avatar A faces the right side, and the avatar B faces the left side, as shown in FIG. 9, for example. Thereafter, when the participant A and the participant B have a conversation, the display control unit 17 sets a shot breakdown in which the avatar A faces the right side and the avatar B faces the left side. As a result, a participant can naturally apprehend who is conversing with whom. The display control unit 17 determines a display mode that allows a participant who is in the conversation to be naturally apprehended, based on the past shot breakdown.

When some of participants are having a conversation, the display control unit 17 may specify avatars having the conversation and determine a viewpoint such that all of the avatars having the conversation are within one screen. The display control unit 17 may move positions of the avatars in a virtual space such that the avatars having the conversation are close to each other. Alternatively, the display control unit 17 may divide the screen into a plurality of areas and display an avatar having the conversation in each of the areas.

Depending on a role (speaker, facilitator, or the like) of a participant using the terminal 10, the display control unit 17 may differentiate a screen configuration of the participant from that of other participants. A screen of the facilitator is divided into frames, and a speaker and a participant who is watching a screen intently are displayed, for example. The facilitator can look at the screen and give the participant who is watching the screen intently an opportunity to speak.

### Modified Example

Next, processing that allows avatars having a conversation to be close to each other will be described.

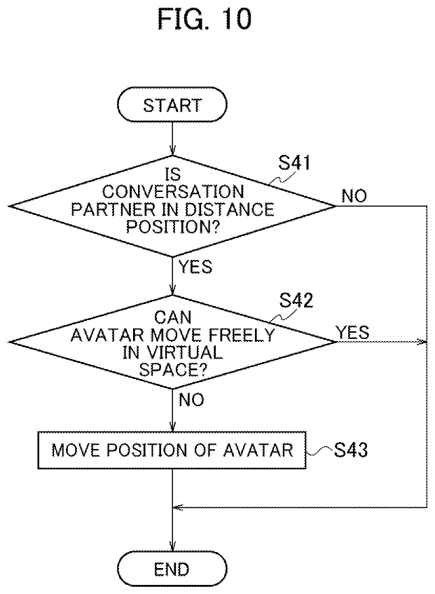

With reference to a flowchart of FIG. 10, a flow of the processing that allows the avatars having the conversation to be close to each other will be described. The processing of FIG. 10 is performed by each terminal 10 of two or more participants having a conversation as needed.

In step S41, the terminal 10 determines whether an avatar of a participant who operates the terminal 10 and an avatar with whom the avatar is having a conversation are located far from each other. If the avatars having the conversation are distant from each other by a prescribed distance in a virtual space, the terminal 10 determines that the avatars are located far from each other, for example. Alternatively, if there is another avatar between the avatars having the conversation, the terminal 10 may determine that the avatars are located far from each other. If the avatars having the conversation are not located far from each other, the processing ends.

If the avatars having the conversation are located far from each other, in step S42, the terminal 10 determines whether the participant can freely move the avatar, based on a type of the terminal 10 itself. A participant using a VR device as the terminal 10 can freely move an avatar, but it is difficult for a participant using a smartphone as the terminal 10 to freely move an avatar, for example. If it is possible to freely move the avatar, the terminal 10 ends the processing. By comparing a type of each terminal 10 of participants having a conversation, the terminal 10 may determine whether it is difficult to freely move avatars. For example, if a participant using a personal computer as the terminal 10 and a participant using a smartphone as the terminal 10 are having a conversation, the terminal 10 may determine that it is difficult to freely move the avatar of the participant using the smartphone. This is because since a keyboard and a mouse are connected to a personal computer, movement of the avatar using the personal computer is easier than movement of the avatar using the smartphone.

If it is difficult to freely move the avatar, in step S43, the terminal 10 moves a position of an avatar of a participant operating the terminal 10 close to an avatar with whom the avatar is having a conversation.

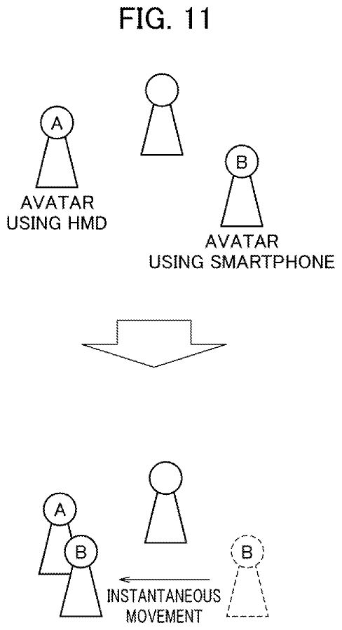

In an example shown in FIG. 11, a conversation is made between an avatar A of a participant using a VR device (hereinafter referred to as terminal 10A) as the terminal 10 and an avatar B of a participant using a smartphone (hereinafter referred to as terminal 10B) as the terminal 10. In this case, the terminal 10A determines in step S32 that it is possible to freely move the avatar A, and the terminal 10B determines in step S32 that it is difficult to freely move the avatar B. In step S33, the terminal 10B moves a position of the avatar B closer to the avatar A. When the avatar B moves instantaneously, the terminal 10B generates a warp effect (for example, glitter or the like) at a position before movement of the avatar B and a position after the movement to express that the avatar B has moved instantaneously, and the terminal 10A darkens a screen momentarily to switch a shot breakdown.

Next, an operation of an avatar by a participant using the terminal 10 will be described.

As shown in FIG. 12, the terminal 10 may arrange icons 110 in a screen 100 and receive operations from participants. In each icon 110, a drawing pattern of an action one wants an avatar to perform is drawn. When each participant touches each icon 110, the terminal 10 generates and transmits control data of an action corresponding to each icon 110. The control data may include not only the action of the avatar but also a background, effect, and viewpoint.

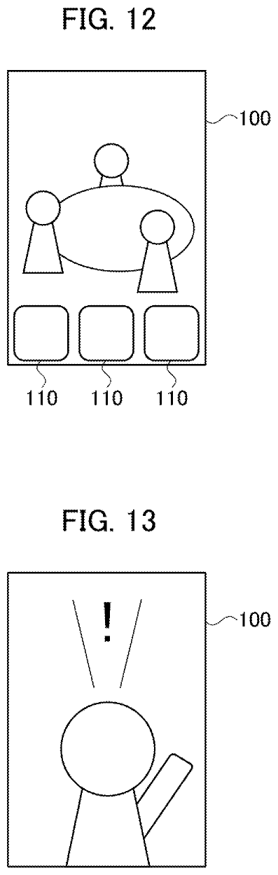

The terminal 10 that has received the control data controls a corresponding avatar according to the control data. If the control data includes the background, effect, and viewpoint, the terminal arranges the background and effect according to an instruction of the control data and sets the viewpoint in a virtual space. FIG. 9 is an example of the screen 100 when a participant with opinions selects an icon indicating an action of having an avatar raise his/her hand, for example. In an example of FIG. 13, the avatar raises his/her hand, and a viewpoint in which the avatar is viewed from a front side is set, and an effect of “!” is displayed above a head of the avatar.

As described above, the terminal 10 of the present embodiment is a terminal for participating in the conference held in the virtual space in which the avatar of the participant is arranged, and the terminal includes: the collecting unit 11 for collecting the voices of the participant; the control unit 13 for generating the control data for controlling the avatar of the participant; the determining unit 14 for determining the state of the participant; the transmitting unit 15 for transmitting the voice data, control data, and determination result of the participant; the receiving unit 16 for receiving the voice data, control data, and determination result of the other participant; the display control unit 17 for determining the display mode of the conference based on the determination results of the participant and the other participant; and the display unit 18 for reproducing the voice data, controlling the avatar based on the control data, and displaying the screen of the conference according to the display mode. This allows the participant to participate in the conference held in the virtual space as the avatar, and therefore the stress that the participant is being watched by other persons can be reduced. The atmosphere of the entire conference can be reflected in a display of the conference by totaling the states of the participant and determining the display mode of the conference.

### REFERENCE SIGNS LIST

10 Terminal
11 Collecting unit
12 Image capturing unit
13 Control unit
14 Determining unit
15 Transmitting unit
16 Receiving unit
17 Display control unit
18 Display unit
30 Server

1. A terminal for participating in a conference held in a virtual space in which an avatar of a participant is arranged, the terminal comprising:
a collecting unit, comprising one or more processors, configured to collect a voice of the participant;
a control unit, comprising one or more processors, configured to generate control data for controlling the avatar of the participant;
a determining unit, comprising one or more processors, configured to determine a state of the participant;
a transmitting unit, comprising one or more processors, configured to transmit voice data, the control data, and a determination result of the participant;
a receiving unit, comprising one or more processors, configured to receive voice data, control data, and a determination result of another participant;
a display control unit, comprising one or more processors, configured to determine a display mode of the conference based on the determination result of the participant and the determination result of the other participant; and
a display unit, comprising one or more processors, configured to reproduce the voice data, control the avatar based on the control data, and display a screen of the conference according to the display mode.

2. The terminal according to claim 1, comprising:
an image capturing unit, comprising one or more processors, configured to obtain a captured image of the participant, wherein
the determining unit determines, from the captured image, whether the participant is looking at the screen, and
the display control unit totals the determination results and determines the display mode of the conference based on a totaled result.

3. The terminal according to claim 2, wherein
the display control unit determines a viewpoint when rendering the virtual space or a division of the screen into frames, based on the totaled result.

4. The terminal according to claim 1, wherein
the display control unit stores a past shot breakdown in which an avatar is displayed, specifies a participant who is in a conversation, based on the determination result, and determines a shot breakdown of an avatar of the participant who is in the conversation, based on the past shot breakdown.

5. The terminal according to claim 1, wherein
when the participant is in a conversation with the other participant, a position of the avatar of the participant is moved close to an avatar of the other participant according to a type of the terminal.

6. An information processing method for participating in a conference held in a virtual space in which an avatar of a participant is arranged, the information processing method comprising:
a computer collecting a voice of the participant;
the computer generating control data for controlling the avatar of the participant;
the computer determining a state of the participant;
the computer transmitting voice data, the control data, and a determination result of the participant;
the computer receiving voice data, control data, and a determination result of another participant;
the computer determining a display mode of the conference based on the determination result of the participant and the determination result of the other participant; and
the computer reproducing the voice data, controlling the avatar based on the control data, and displaying a screen of the conference according to the display mode.

7. (canceled)

8. A recording medium storing a program for causing a computer to operate as a terminal for participating in a conference held in a virtual space in which an avatar of a participant is arranged, the program causing the computer to perform:
collecting a voice of the participant;
generating control data for controlling the avatar of the participant;
determining a state of the participant;
transmitting voice data, the control data, and a determination result of the participant;
receiving voice data, control data, and a determination result of another participant; and
determining a display mode of the conference based on the determination result of the participant and the determination result of the other participant.
